(19) United States
(12) Patent Application Publication
(10) Pub. No.: US 2024/0210276 A1
(43) Pub. Date: Jun. 27, 2024

(54) Signal Processing Method, Signal Processing Device, And Signal Processing Program

(71) Applicant: SEIKO EPSON CORPORATION, Tokyo (JP)

(72) Inventor: Masayoshi TODOROKIHARA, Suwa (JP)

(21) Appl. No.: 18/395,835

(22) Filed: Dec. 26, 2023

(30) Foreign Application Priority Data
Dec. 27, 2022 (JP) 2022-209359

(51) Int. Cl. G01M 13/00

(52) U.S. Cl. CPC G01M 13/00

(57) ABSTRACT

A signal processing method includes a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more, a frequency spectrum generation step of generating an i-th frequency spectrum for each integer i based on the i-th time waveform, and a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

The present application is based on, and claims priority from JP Application Serial Number 2022-209359, filed Dec. 27, 2022, the disclosure of which is hereby incorporated by reference herein in its entirety.

### BACKGROUND

### 1. Technical Field

The present disclosure relates to a signal processing method, a signal processing device, and a signal processing program.

### 2. Related Art

In the related art, in a vibration diagnosis of a rotating device, when a diagnosis using rotation phase information is performed, a vibration time waveform and a rotation pulse signal are obtained from the rotating device, a vibration waveform component synchronized with the rotation pulse signal is extracted, and the diagnosis is performed. For example, “API Standard 670 Machinery Protection Systems” FIFTH EDITION, NOVEMBER 2014 is an example of the related art, which discloses a method and a procedure for performing a target diagnosis by obtaining a vibration time waveform or an orbit diagram with a rotation pulse serving as an absolute reference, extracting a vibration waveform component synchronized with the rotation pulse to obtain a full spectrum, and the like.

In the related art, in order to obtain the rotation pulse signal from the rotating device and extract the vibration waveform component synchronized with the rotation pulse signal, it is required to perform preprocessing using signal conditioners such as a PLL, a tracking filter, or a low-pass filter in combination.

### SUMMARY

An aspect of a signal processing method according to the present disclosure includes: a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more; a frequency spectrum generation step of generating an i-th frequency spectrum for each integer i based on the i-th time waveform; and a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

An aspect of a signal processing device according to the present disclosure includes: a time waveform acquisition circuit configured to acquire, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more; a frequency spectrum generation circuit configured to generate an i-th frequency spectrum for each integer i based on the i-th time waveform; and a first state index calculation circuit configured to calculate, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

An aspect of a signal processing program according to the present disclosure is a program for causing a computer to execute: a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more; a frequency spectrum generation step of generating an i-th frequency spectrum for each integer i based on the i-th time waveform; and a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

### BRIEF DESCRIPTION OF THE DRAWINGS

FIG. 1 is a diagram showing a forced vibration model of a system with one degree of freedom in the case of damping.

FIG. 2 is a flowchart showing a procedure of a signal processing method according to a first embodiment.

FIG. 3 is a schematic perspective view showing a configuration of a vacuum pump.

FIG. 4 is a diagram showing an example of time waveforms.

FIG. 5 is a diagram showing an example of frequency spectra.

FIG. 6 is a diagram showing an example of Fourier phases.

FIG. 7 is a diagram showing an example of phase differences.

FIG. 8 is a diagram showing an example of a temporal change of phase differences.

FIG. 9 is a diagram showing a configuration example of a signal processing device that executes the signal processing method according to the first embodiment.

FIG. 10 is a flowchart showing a procedure of a signal processing method according to a second embodiment.

FIG. 11 is a diagram showing an example of phase differences.

FIG. 12 is a diagram showing an example of a temporal change of phase differences.

FIG. 13 is a diagram showing a configuration example of a signal processing device that executes the signal processing method according to the second embodiment.

FIG. 14 is a flowchart showing a procedure of a signal processing method according to a third embodiment.

FIG. 15 is a diagram showing an example of Lissajous figures.

FIG. 16 is a diagram showing an example of a temporal change of Lissajous figures.

FIG. 17 is a diagram showing an example of a temporal change of Lissajous figures.

FIG. 18 is a diagram showing another example of a temporal change of Lissajous figures.

FIG. 19 is a diagram showing another example of a temporal change of Lissajous figures.

FIG. 20 is a diagram showing another example of a temporal change of Lissajous figures.

FIG. 21 is a diagram showing a configuration example of a signal processing device that executes the signal processing method according to the third embodiment.

### DESCRIPTION OF EMBODIMENTS

Hereinafter, embodiments will be described with reference to the drawings. It should be noted that embodiments to be described below are not intended to limit contents of the present disclosure described in the claims. Not all configurations described below are necessarily essential constituent elements of the present disclosure.

### 1. First Embodiment

### 1-1. Consideration

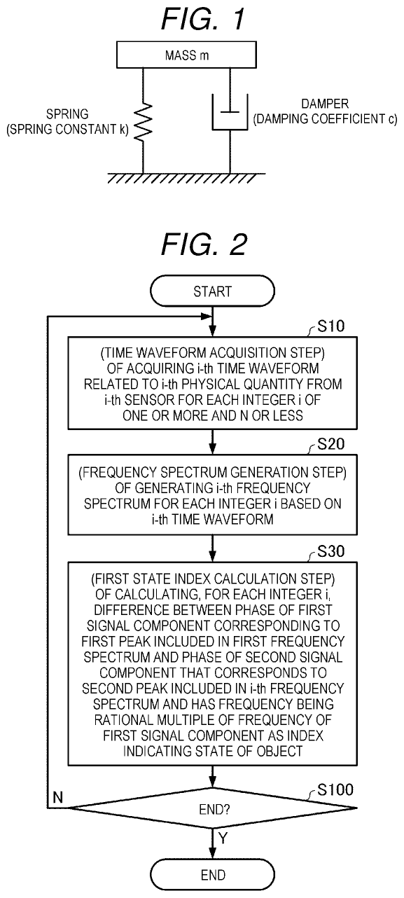

As shown in FIG. 1, a forced vibration model of a system with one degree of freedom in the case of damping is assumed, and a damping constant is calculated based on vibration phase information. A solution of a motion equation when a harmonic external force is applied to a mass m is given by a sum of a basic solution when the harmonic external force is set to 0 and a special solution corresponding to the harmonic external force, and a behavior of the special solution may be considered for a vibration in a steady state corresponding to the model shown in FIG. 1. The motion equation is expressed by Equation (1) in which ω is an angular frequency of the harmonic external force. In Equation (1), x is a displacement of the mass m, k is a spring constant, and c is a damping coefficient.

$$m \ddot{x} + c \dot{x} + kx = X sin ω t \qquad ( 1 )$$

A special solution of Equation (1) is expressed by Equation (2). φ is given by Equation (3), ωₙ is a resonance angular frequency of a system, and ζ is a damping constant.

$$\begin{matrix}x = X sin ( ω t - ϕ ) & ( 2 ) \\ ϕ = \frac{2 ζ ( \frac{ω}{{ω}_{n}} )}{1 - {( \frac{ω}{{ω}_{n}} )}^{2}} & ( 3 )\end{matrix}$$

When Equation (3) is solved for ζ, Equation (4) is obtained.

$$ζ = \frac{1 - {( \frac{ω}{{ω}_{n}} )}^{2}}{2 ( \frac{ω}{{ω}_{n}} )} tan ϕ \qquad ( 4 )$$

When an external force F is expressed in Equation (5), a vibration in a steady state is given by a sum of corresponding special solutions as in Equation (6).

$$\begin{matrix}F = {A}_{1} sin ( ω t - {ϕ}_{10} ) + {A}_{2} sin ( 2 ω t - {ϕ}_{20} ) + ⋯ + {A}_{m} sin ( m ω t - {ϕ}_{m 0} ) + ⋯ & ( 5 ) \\ x = {A}_{1} sin ( ω t - {ϕ}_{1} - {ϕ}_{10} ) + {A}_{2} sin ( 2 ω t - {ϕ}_{2} - {ϕ}_{20} ) + ⋯ + {A}_{m} sin ( m ω t - {ϕ}_{m} - {ϕ}_{m 0} ) + ⋯ & ( 6 )\end{matrix}$$

In Equation (4), a relationship of Equation (7) is obtained by replacing φ with φₘ, replacing w with mω, and replacing ζ with ζₘ.

$${ζ}_{m} = \frac{1 - {{m}^{2} ( \frac{ω}{{ω}_{n}} )}^{2}}{2 m ( \frac{ω}{{ω}_{n}} )} tan {ϕ}_{m} \qquad ( 7 )$$

When considering a special case where the external force F is known, if phases φₖ and φ₁ for two harmonic vibrations in a steady state are known, a relationship of Equation (8) is obtained by setting ζₖ=ζ₁ under an assumption that a frequency dependence of the damping constant (can be ignored. Since ω is known, ωₙ can be calculated from Equation (8), and the damping constant (can be calculated from Equation (7).

$$\frac{1 - {{k}^{2} ( \frac{ω}{{ω}_{n}} )}^{2}}{2 k} tan {ϕ}_{k} = \frac{1 - {{l}^{2} ( \frac{ω}{{ω}_{n}} )}^{2}}{2 l} tan {ϕ}_{l} \qquad ( 8 )$$

Generally, it is known that deterioration of components of a rotating device appears as a change in the spring constant k or the damping constant ζ before the deterioration becomes apparent as an increase in a vibration strength. As described above, the damping constant ζ can be calculated by acquiring two or more phases for a plurality of vibration peaks corresponding to a fundamental wave and a harmonic wave. This suggests that a vibration phase includes information corresponding to a state of the rotating device, and a difference between the two phases can be set as an index indicating a state of an analysis target. That is, a change in one of the spring constant k and the damping constant ζ can be suspected by monitoring using a value such as (φ₁+φ₁₀)−(φₖ+φₖ₀) as an index.

### 1-2. Signal Processing Method

FIG. 2 is a flowchart showing a procedure of a signal processing method according to the first embodiment. As shown in FIG. 2, the signal processing method according to the first embodiment includes a time waveform acquisition step S10, a frequency spectrum generation step S20, and a first state index calculation step S30. In the signal processing method according to the first embodiment, some of these steps may be omitted or changed, or other steps may be added. The signal processing method according to the first embodiment is executed by, for example, a signal processing device 100. A configuration example of the signal processing device 100 that executes the signal processing method according to the first embodiment will be described later.

As shown in FIG. 2, first, in the time waveform acquisition step S10, the signal processing device 100 acquires an i-th time waveform related to an i-th physical quantity from an i-th sensor for each integer i of 1 or more and N or less. N is a predetermined integer of 1 or more.

The i-th physical quantity is a physical quantity generated when an external force, a velocity, or a displacement including at least a periodic variation acts on an object.

The i-th time waveform may be time-series data of a digital signal output from the i-th sensor, or time-series data of a digital signal obtained by converting an analog signal output from the i-th sensor by an analog front end. The object is an object to be subjected to signal processing, and a type of the object is not particularly limited, and may be, for example, various devices such as a motor having a rotating mechanism or a vibration mechanism, a structure such as a bridge or a building that vibrates due to an external force, or an electric circuit that generates a signal having periodicity. Hereinafter, when the integer N is 2 or more, first to N-th time waveforms are synchronized with one another, and when two or more of the first to N-th time waveforms are not synchronized with one another, the first to N-th time waveforms may be synchronized by resampling at a predetermined sampling rate.

Types of first to N-th physical quantities are not particularly limited, and for example, the first to N-th physical quantities may be an acceleration, an angular velocity, a velocity, a displacement, pressure, a current, and a voltage. The first to N-th physical quantities may be the same type of physical quantity. That is, first to N-th sensors may be sensors that detect the same type of physical quantity. For example, with regard to an x axis, a y axis, and a z axis orthogonal to one other, the first sensor may detect a velocity in an x-axis direction as the first physical quantity, the second sensor may detect a velocity in a y-axis direction as the second physical quantity, and the third sensor may detect a velocity in a z-axis direction as the third physical quantity. Alternatively, some of the first to N-th sensors may be a sensor that detects a type of a physical quantity different from that detected by the other sensors. For example, the first sensor may detect an acceleration in the x-axis direction as the first physical quantity, and the second sensor may detect an angular velocity in the y-axis direction as the second physical quantity. The first to N-th sensors may be, for example, sensors using MEMS or sensors using a quartz crystal vibrator. MEMS is an abbreviation for micro electro mechanical systems. The first to N-th sensors may be incorporated in one device such as an IMU, or at least one of the first to N-th sensors may be physically separated from the other sensors. IMU is an abbreviation for inertial measurement unit.

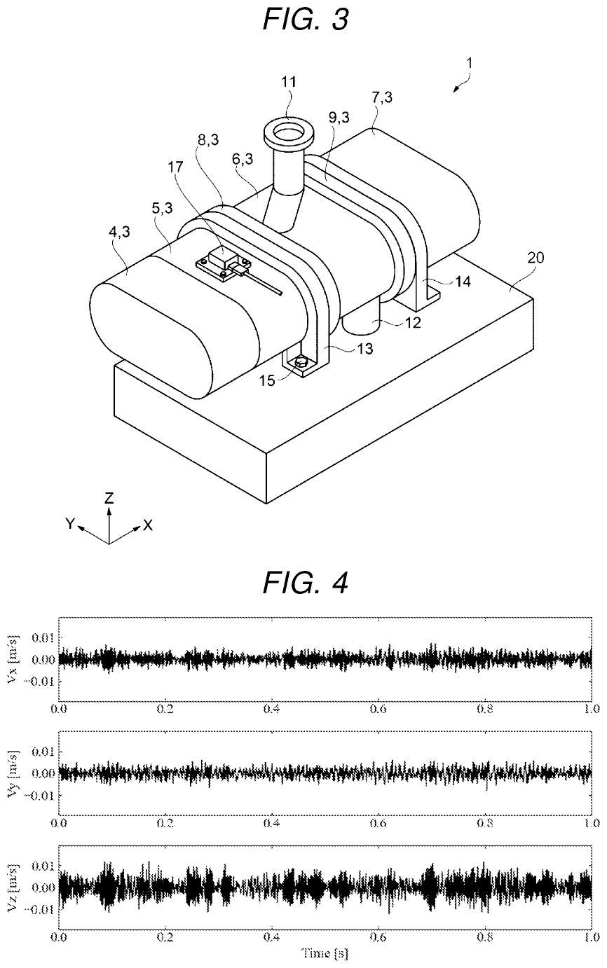

FIG. 3 shows a vacuum pump 1 as an example of an object. As shown in FIG. 3, the vacuum pump 1 is provided on a base 20. The vacuum pump 1 has a columnar shape having a substantially long circle cross section. A longitudinal direction of the vacuum pump 1 is defined as an X direction. A long axis direction of the long circle is defined as a Y direction, and a short axis direction of the long circle is defined as a Z direction.

The vacuum pump 1 includes a housing 3. The housing 3 includes a motor case 4, a coupling portion 5, a pump case 6, and a gear case 7 arranged from a −X direction side toward a +X direction side. The housing 3 includes a first side wall 8 as a bearing casing between the coupling portion 5 and the pump case 6. The housing 3 includes a second side wall 9 between the pump case 6 and the gear case 7.

An intake pipe 11 is coupled to a surface on a +Z direction side of the pump case 6. An exhaust pipe 12 is coupled to a surface on a −Z direction side of the pump case 6.

The coupling portion 5 includes a first leg portion 13 and a second leg portion on a side close to the base 20. The first leg portion 13 is disposed on a −Y direction side, and the second leg portion is disposed on a +Y direction side. The gear case 7 includes a third leg portion 14 and a fourth leg portion on a side close to the base 20. The third leg portion 14 is disposed on the −Y direction side, and the fourth leg portion is disposed on the +Y direction side. The first leg portion 13 to the fourth leg portion are fastened to the base 20 by first bolts 15.

A sensor unit 17 is attached to the housing 3. The sensor unit 17 is attached to, for example, the coupling portion 5. The sensor unit 17 includes the first to N-th sensors (not shown) inside the sensor unit 17. For example, the first sensor may be a velocity sensor that detects a velocity in the x-axis direction, the second sensor may be a velocity sensor that detects a velocity in the y-axis direction, and the third sensor may be a velocity sensor that detects a velocity in the z-axis direction. For example, the sensor unit 17 is attached such that the x-axis direction, the y-axis direction, and the z-axis direction respectively coincide with the +X direction, the +Y direction, and the +Z direction.

FIG. 4 shows an example of the first to N-th time waveforms acquired by the signal processing device 100 in the time waveform acquisition step S10 with the integer N being set to 3. The three time waveforms shown in FIG. 4 are time waveforms of three-axis velocities based on output signals of a three-axis velocity sensor attached to a rotating device such as the vacuum pump 1 shown in FIG. 3. In the example shown in FIG. 4, the integer N is 3, a time waveform of an x-axis velocity Vx corresponds to the first time waveform, a time waveform of a y-axis velocity Vy corresponds to the second time waveform, and a time waveform of a z-axis velocity Vz corresponds to the third time waveform. In FIG. 4, a horizontal axis represents time and a vertical axis represents a velocity. The x-axis velocity Vx is a velocity detected by an x-axis velocity sensor serving as a first sensor incorporated in the three-axis velocity sensor. The y-axis velocity Vy is a velocity detected by a y-axis velocity sensor serving as a second sensor incorporated in the three-axis velocity sensor. The z-axis velocity Vz is a velocity detected by a z-axis velocity sensor serving as a third sensor incorporated in the three-axis velocity sensor. Only time waveforms of one second among acquired time waveforms are shown in FIG. 4, but in practice, time waveforms of a time length required for processing in step S20 and subsequent steps, for example, 30 seconds or more are acquired.

As shown in FIG. 2, in the frequency spectrum generation step S20, the signal processing device 100 generates an i-th frequency spectrum for each integer i of 1 or more and N or less based on the i-th time waveform acquired in the time waveform acquisition step S10. For example, the signal processing device 100 may perform a fast Fourier transform on the first to N-th time waveforms to generate first to N-th frequency spectra.

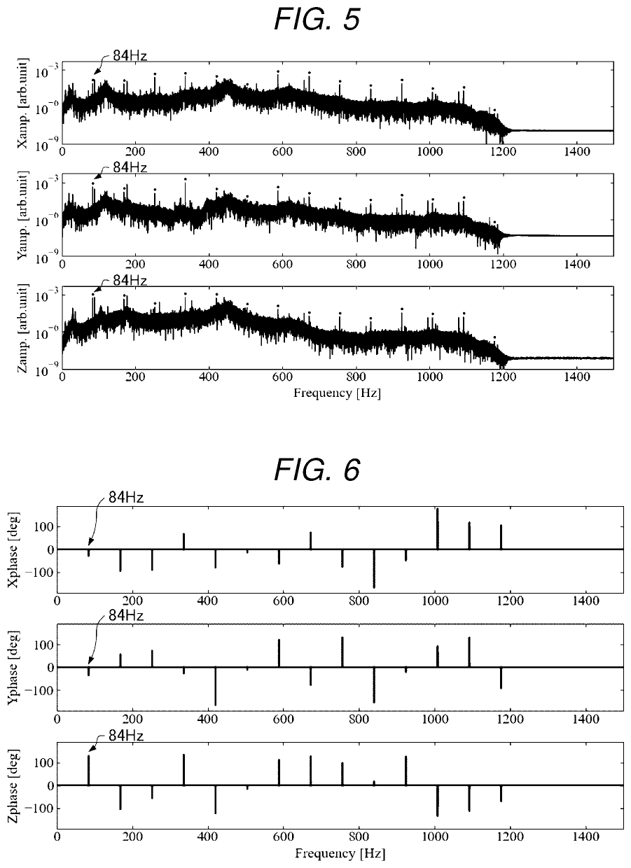

FIG. 5 shows respective frequency spectra of a time waveform of the x-axis velocity Vx, a time waveform of the y-axis velocity Vy, and a time waveform of the z-axis velocity Vz in FIG. 4. In FIG. 5, a horizontal axis represents a frequency and a vertical axis represents an intensity. For example, in the frequency spectrum generation step S20, the signal processing device 100 generates a frequency spectrum of the x-axis velocity Vx as a first frequency spectrum, generates a frequency spectrum of the y-axis velocity Vy as a second frequency spectrum, and generates a frequency spectrum of the z-axis velocity Vz as a third frequency spectrum.

Next, as shown in FIG. 2, in the first state index calculation step S30, the signal processing device 100 calculates a difference between a phase of a first signal component corresponding to a first peak included in the first frequency spectrum generated in the frequency spectrum generation step S20 and a phase of a second signal component that corresponds to a second peak included in the i-th frequency spectrum and has a frequency that is a rational multiple of a frequency of the first signal component for each integer i of 1 or more and N or less as an index indicating a state of an object. Specifically, first, in the frequency spectrum generation step S20, the signal processing device 100 calculates a Fourier phase (pi of the first signal component from a real part and an imaginary part of a frequency function F(ω₁) of the first signal component corresponding to one of a plurality of peaks obtained by performing a fast Fourier transform on the first time waveform. Next, for each integer i, the signal processing device 100 calculates a Fourier phase φ₂ of the second signal component from a real part and an imaginary part of a frequency function F(ω₂) of the second signal component corresponding to one of a plurality of peaks obtained by performing a fast Fourier transform on the i-th time waveform. Next, the signal processing device 100 calculates a difference between a phase of the first signal component and a phase of the second signal component by subtracting the Fourier phase φ₁ scaled to the Fourier phase φ₂ from the Fourier phase φ₂. For example, when a frequency of the second signal component is twice a frequency of the first signal component, the difference between the phase of the first signal component and the phase of the second signal component is calculated from φ₂−2φ₁ by scaling φ₁ by 2. For example, the first signal component may be a fundamental wave component, and the second signal component may be a fundamental wave component and each of a plurality of high harmonic wave components. That is, a frequency of the second signal component may be a natural number multiple of a frequency of the first signal component.

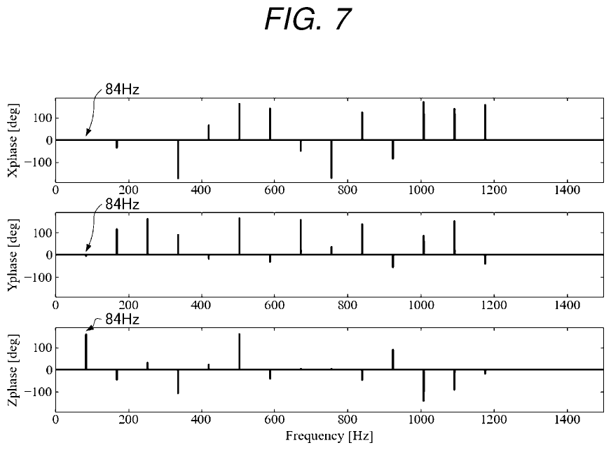

FIG. 6 shows an example of Fourier phases of the first signal component and the second signal component at the x-axis velocity Vx, the y-axis velocity Vy, and the z-axis velocity Vz shown in FIG. 4. FIG. 7 shows an example of a phase difference at each of the x-axis velocity Vx, the y-axis velocity Vy, and the z-axis velocity Vz calculated based on the Fourier phases shown in FIG. 6. In FIGS. 6 and 7, a horizontal axis represents a frequency and a vertical axis represents a phase. As shown in FIG. 5, a frequency spectrum of the x-axis velocity Vx, a frequency spectrum of the y-axis velocity Vy, and a frequency spectrum of the z-axis velocity Vz each include a plurality of peaks, and the plurality of peaks with black circles that are some of the peaks are peaks of about 84 Hz which is a fundamental wave component and peaks of second to 14th harmonic wave components. FIG. 6 shows Fourier phases of the fundamental wave component of about 84 Hz and the second to 14th harmonic wave components included in each of the x-axis velocity Vx, the y-axis velocity Vy, and the z-axis velocity Vz. FIG. 7 shows a phase difference obtained by subtracting a Fourier phase of the scaled first signal component from a Fourier phase of the second signal component with the fundamental wave component of about 84 Hz included in the x-axis velocity Vx being set as the first signal component, and the fundamental wave component of about 84 Hz and the second to 14th harmonic wave components included in each of the x-axis velocity Vx, the y-axis velocity Vy, and the z-axis velocity Vz being set as the second signal component.

As shown in FIG. 2, the signal processing device 100 repeatedly performs steps S10 to S30 until the signal processing ends (Y in step S100).

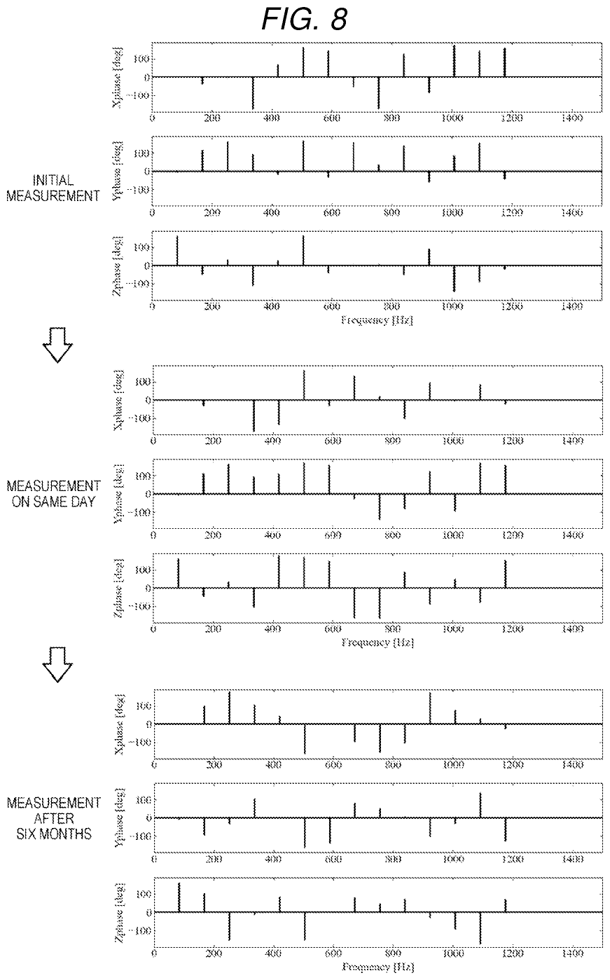

From the above consideration, a user can monitor a difference between a phase of the first signal component and a phase of the second signal component based on the first to N-th time waveforms, and can estimate that a state of the object changes when a temporal change is observed in the difference. FIG. 8 shows an example of a temporal change in a phase difference at each of the x-axis velocity Vx, the y-axis velocity Vy, and the z-axis velocity Vz shown in FIG. 7. In the example shown in FIG. 8, even when a measurement is performed on the same day, the phase difference changes in a fifth harmonic wave, a seventh harmonic wave, and higher harmonic waves. After six months, a change in the phase difference is small in the fundamental wave, a change in the phase difference is large in all harmonic waves, and it is estimated that a state of the object changes during the six months.

### 1-3. Signal Processing Device

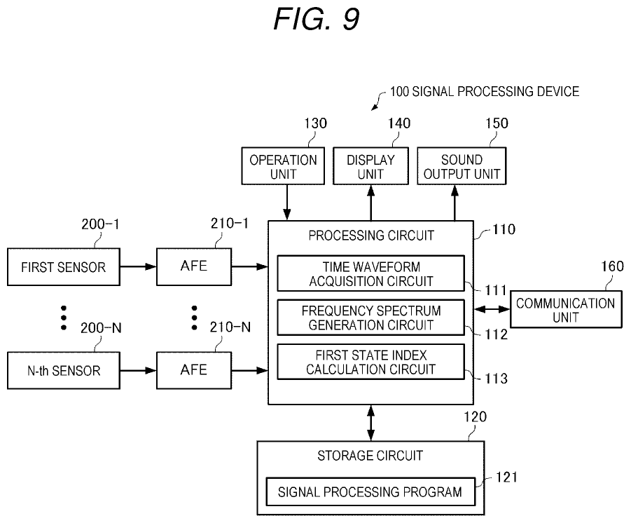

FIG. 9 is a diagram showing a configuration example of the signal processing device 100 that executes the signal processing method according to the first embodiment. As shown in FIG. 9, the signal processing device 100 includes first to N-th sensors 200-1 to 200-N, N analog front ends 210-1 to 210-N, a processing circuit 110, a storage circuit 120, an operation unit 130, a display unit 140, a sound output unit 150, and a communication unit 160. The signal processing device 100 may have a configuration in which some of the components shown in FIG. 9 are omitted or changed, or other components are added. For example, the first to N-th sensors 200-1 to 200-N and the analog front ends 210-1 to 210-N may not be components of the signal processing device 100.

For each integer i of 1 or more and N or less, the i-th sensor 200-i detects an i-th physical quantity generated by an external force, a velocity, or a displacement acting on an object, and outputs a signal having a magnitude corresponding to the detected i-th physical quantity. Output signals of the first to N-th sensors 200-1 to 200-N are respectively input to the analog front ends 210-1 to 210-N.

The analog front ends 210-1 to 210-N perform amplification processing, A/D conversion processing, or the like on the output signals of the respective first to N-th sensors 200-1 to 200-N, and outputs digital time-series signals.

The processing circuit 110 acquires N digital time-series signals output from the analog front ends 210-1 to 210-N as the first to N-th time waveforms and executes signal processing. Specifically, the processing circuit 110 executes a signal processing program 121 stored in the storage circuit 120 and executes various kinds of calculation processing on the first to N-th time waveforms. In addition, the processing circuit 110 executes various kinds of processing according to an operation signal from the operation unit 130, processing of transmitting a display signal for causing the display unit 140 to display various kinds of information, processing of transmitting a sound signal for causing the sound output unit 150 to generate various sounds, processing of controlling the communication unit 160 to perform data communication with an external device (not shown), and the like. The processing circuit 110 is implemented by, for example, a CPU or a DSP. CPU is an abbreviation for central processing unit, and DSP is an abbreviation for digital signal processor.

The processing circuit 110 functions as a time waveform acquisition circuit 111, a frequency spectrum generation circuit 112, and a first state index calculation circuit 113 by executing the signal processing program 121. That is, the signal processing device 100 includes the time waveform acquisition circuit 111, the frequency spectrum generation circuit 112, and the first state index calculation circuit 113.

The time waveform acquisition circuit 111 acquires the i-th time waveform related to the i-th physical quantity from the i-th sensor 200-i for each integer i of 1 or more and N or less. N is a predetermined integer of 1 or more. That is, the time waveform acquisition circuit 111 executes the time waveform acquisition step S10 shown in FIG. 2. The first to N-th time waveforms acquired by the time waveform acquisition circuit 111 are stored in the storage circuit 120.

The frequency spectrum generation circuit 112 generates the i-th frequency spectrum based on the i-th time waveform acquired by the time waveform acquisition circuit 111 for each integer i of 1 or more and N or less. That is, the frequency spectrum generation circuit 112 executes the frequency spectrum generation step S20 shown in FIG. 2. The first to N-th frequency spectra generated by the frequency spectrum generation circuit 112 are stored in the storage circuit 120.

The first state index calculation circuit 113 calculates a difference between a phase of a first signal component corresponding to a first peak included in the first frequency spectrum generated by the frequency spectrum generation circuit 112 and a phase of a second signal component that corresponds to a second peak included in the i-th frequency spectrum and has a frequency that is a rational multiple of a frequency of the first signal component for each integer i of 1 or more and N or less as an index indicating a state of an object. That is, the first state index calculation circuit 113 executes the first state index calculation step S30 shown in FIG. 2. The index calculated by the first state index calculation circuit 113 is stored in the storage circuit 120.

As described above, the signal processing program 121 is a program that causes the processing circuit 110 which is a computer to execute the time waveform acquisition step S10, the frequency spectrum generation step S20, and the first state index calculation step S30.

The storage circuit 120 includes a ROM and a RAM (not shown). ROM is an abbreviation for read only memory, and RAM is an abbreviation for random access memory. The ROM stores various programs such as the signal processing program 121 and predetermined data, and the RAM stores data generated by the processing circuit 110. The RAM is also used as a work area of the processing circuit 110, and stores programs and data read from the ROM, data input from the operation unit 130, and data temporarily generated by the processing circuit 110.

The operation unit 130 is an input device including an operation key, a button switch, and the like, and outputs an operation signal corresponding to an operation of a user to the processing circuit 110.

The display unit 140 is a display device implemented by an LCD or the like, and displays various kinds of information based on a display signal output from the processing circuit 110. LCD is an abbreviation for liquid crystal display. The display unit 140 may be provided with a touch panel functioning as the operation unit 130. For example, the display unit 140 may display a screen including at least a part of various kinds of data stored in the storage circuit 120 based on a display signal output from the processing circuit 110.

The sound output unit 150 is implemented by a speaker or the like, and generates various sounds based on a sound signal output from the processing circuit 110. For example, the sound output unit 150 may generate a sound indicating the start or end of the signal processing based on the sound signal output from the processing circuit 110.

The communication unit 160 performs various kinds of control for establishing data communication between the processing circuit 110 and an external device. For example, the communication unit 160 may transmit at least a part of various kinds of data stored in the storage circuit 120 to an external device, and the external device may display the received information on a display unit (not shown).

At least some of the time waveform acquisition circuit 111, the frequency spectrum generation circuit 112, and the first state index calculation circuit 113 may be implemented by dedicated hardware. The signal processing device 100 may be a single device or may be implemented by a plurality of devices. For example, the first to N-th sensors 200-1 to 200-N and the analog front ends 210-1 to 210-N may be included in a first device, and the processing circuit 110, the storage circuit 120, the operation unit 130, the display unit 140, the sound output unit 150, and the communication unit 160 may be included in a second device separate from the first device. For example, the processing circuit 110 and the storage circuit 120 may be implemented by a device such as a cloud server, and the device may calculate an index and transmit the calculated index to a terminal including the operation unit 130, the display unit 140, the sound output unit 150, and the communication unit 160 via a communication line.

### 1-4. Operation and Effect

According to the signal processing method of the first embodiment, since the signal processing device 100 calculates a difference between the phase of the first signal component and the phase of the second signal component based on the first to N-th time waveforms, a rotation pulse signal is not required, and it is not required to use a PLL, a tracking filter, a low-pass filter, and the like in combination. Since phases of various signal components included in the first to N-th time waveforms include information corresponding to a state of an object, the signal processing device 100 can calculate a difference between the phase of the first signal component included in the first time waveform and the phase of the second signal component included in the first to N-th time waveforms as an index indicating a state of the object. In this manner, according to the signal processing method of the first embodiment, the signal processing device 100 can calculate an index indicating a state of the object without requiring a rotation pulse signal.

According to the signal processing method of the first embodiment, when the integer N is 2 or more, an index based on a plurality of time waveforms is obtained as the index indicating a state of the object.

According to the signal processing method of the first embodiment, when a frequency of the second signal component is set to be a natural number multiple of a frequency of the first signal component, the second signal component becomes a harmonic wave component having the first signal component as a fundamental wave component, and thus the signal processing device 100 can calculate a difference between a phase of the fundamental wave component and a phase of the harmonic wave component as an index indicating a state of the object.

### 2. Second Embodiment

Hereinafter, in the second embodiment, the same components as those of the first embodiment are denoted by the same reference numerals, description overlapping with the first embodiment is omitted or simplified, and contents different from the first embodiment will be mainly described.

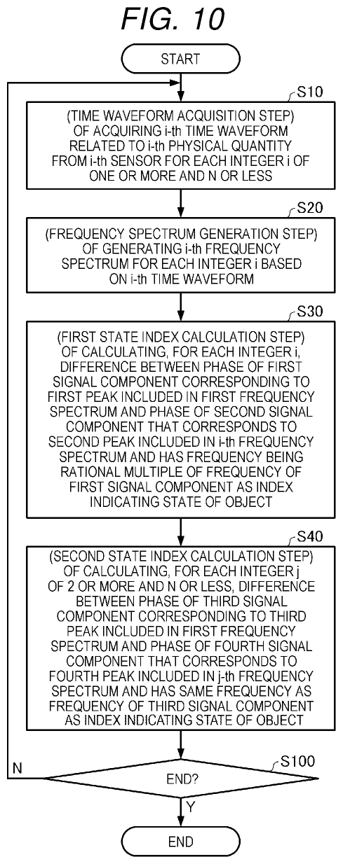

FIG. 10 is a flowchart showing a procedure of a signal processing method according to the second embodiment. As shown in FIG. 10, the signal processing method according to the second embodiment includes the time waveform acquisition step S10, the frequency spectrum generation step S20, the first state index calculation step S30, and a second state index calculation step S40. In the signal processing method according to the second embodiment, some of these steps may be omitted or changed, or other steps may be added. The signal processing method according to the second embodiment is executed by, for example, the signal processing device 100. A configuration example of the signal processing device 100 that executes the signal processing method according to the second embodiment will be described later.

As shown in FIG. 10, first, the signal processing device 100 executes the time waveform acquisition step S10 in a similar manner to that in FIG. 2 to acquire the first to N-th time waveforms. In the second embodiment, the integer N is 2 or more.

Next, the signal processing device 100 executes the frequency spectrum generation step S20 in a similar manner to that in FIG. 2. Next, the signal processing device 100 executes the first state index calculation step S30 in a similar manner to that in FIG. 2.

Next, in the second state index calculation step S40, the signal processing device 100 calculates a difference between a phase of a third signal component corresponding to a third peak included in the first frequency spectrum generated in the frequency spectrum generation step S20 and a phase of a fourth signal component that corresponds to a fourth peak included in a j-th frequency spectrum and has the same frequency as a frequency of the third signal component for each integer j of 2 or more and N or less as an index indicating a state of an object. Specifically, first, in the frequency spectrum generation step S20, the signal processing device 100 calculates a Fourier phase φ₃ of the third signal component from a real part and an imaginary part of a frequency function F(ω₃) of the third signal component corresponding to one of a plurality of peaks obtained by performing a fast Fourier transform on the first time waveform. Next, for each integer j, the signal processing device 100 calculates a Fourier phase φ₄ of the fourth signal component from a real part and an imaginary part of a frequency function F(ω₄) of the fourth signal component that is one of a plurality of peaks obtained by performing a fast Fourier transform on a j-th time waveform and has the same frequency as the third signal component. Next, the signal processing device 100 calculates a difference between a phase of the third signal component and a phase of the fourth signal component by subtracting the Fourier phase φ₃ from the Fourier phase φ₄. For example, both the third signal component and the fourth signal component may be fundamental wave components, or may be harmonic wave components of respective orders.

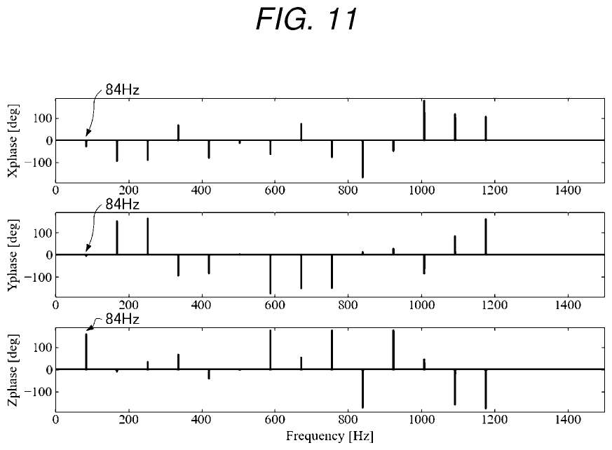

FIG. 11 shows an example of a phase difference at each of the y-axis velocity Vy and the z-axis velocity Vz calculated based on the Fourier phases shown in FIG. 6. FIG. 11 also shows a Fourier phase at the x-axis velocity Vx for reference. In FIG. 11, a horizontal axis represents a frequency and a vertical axis represents a phase. As shown in FIG. 5, a frequency spectrum of the x-axis velocity Vx, a frequency spectrum of the y-axis velocity Vy, and a frequency spectrum of the z-axis velocity Vz each include a plurality of peaks, and the plurality of peaks with black circles that are some of the peaks are peaks of about 84 Hz which is a fundamental wave component and peaks of second to 14th harmonic wave components. FIG. 11 shows a phase difference obtained by subtracting a Fourier phase of the third signal component from a Fourier phase of the fourth signal component with the fundamental wave component of about 84 Hz and each of the second to 14th high harmonic wave components included in the x-axis velocity Vx being set as the third signal component, and the fundamental wave component of about 84 Hz and the second to 14th high harmonic wave components included in each of the y-axis velocity Vy and the z-axis velocity Vz being set as the fourth signal component.

As shown in FIG. 10, the signal processing device 100 repeatedly executes steps S10 to S40 until the signal processing ends (Y in step S100).

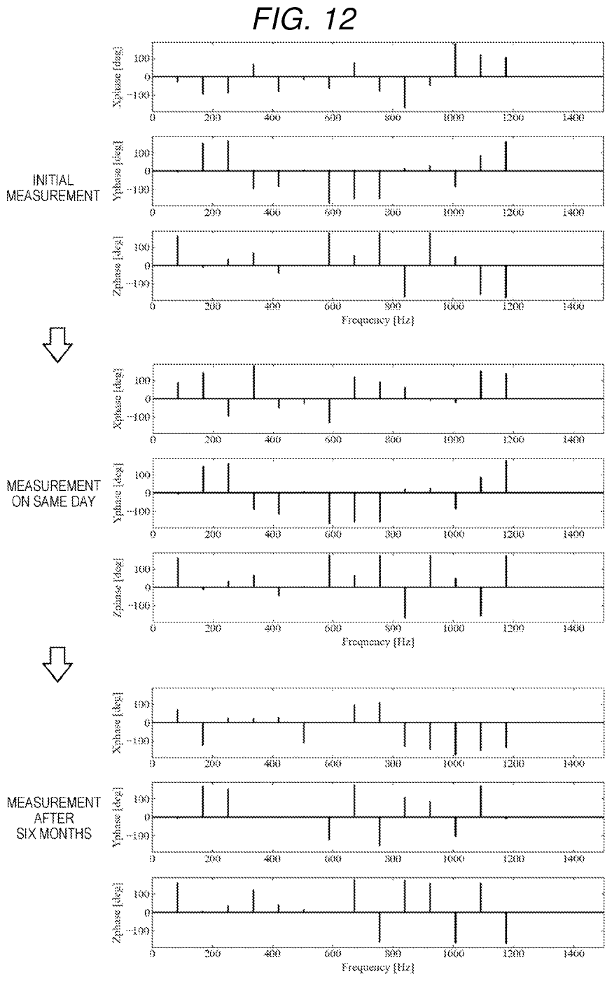

From the above consideration, a user can monitor a difference between a phase of the third signal component and a phase of the fourth signal component based on the first to N-th time waveforms, and can estimate that a state of the object changes when a temporal change is observed in the difference. FIG. 12 shows an example of a temporal change in the phase difference at each of the y-axis velocity Vy and the z-axis velocity Vz shown in FIG. 11. FIG. 12 also shows a temporal change in a Fourier phase of the x-axis velocity Vx for reference. In the example shown in FIG. 12, when a measurement is performed on the same day, a change in a phase difference is minute except for the 14th harmonic wave. After six months, the phase difference greatly changes in the fourth, fifth, seventh, tenth, and higher harmonic waves, and it is estimated that a state of the object changes during the six months.

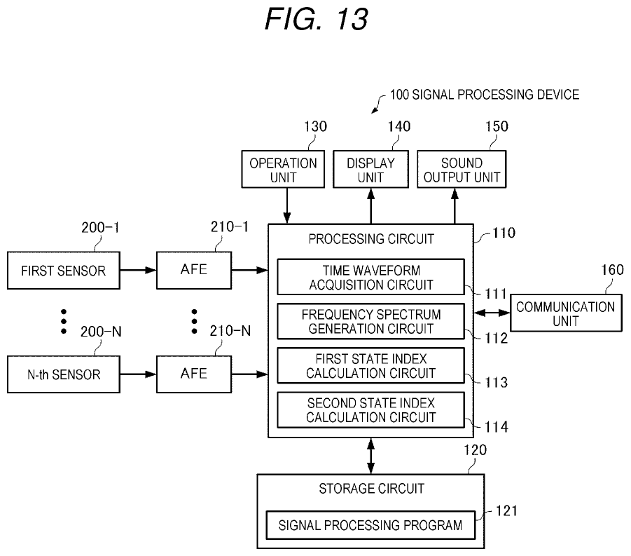

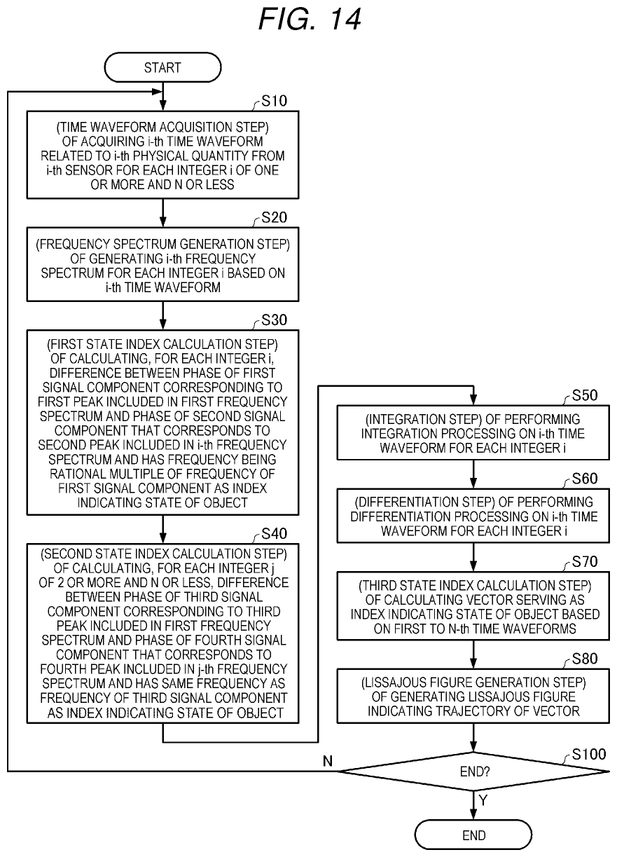

FIG. 13 shows a configuration example of the signal processing device 100 that executes the signal processing method according to the second embodiment. As shown in FIG. 13, the signal processing device 100 includes the first to N-th sensors 200-1 to 200-N, the N analog front ends 210-1 to 210-N, the processing circuit 110, the storage circuit 120, the operation unit 130, the display unit 140, the sound output unit 150, and the communication unit 160. The signal processing device 100 may have a configuration in which some of the components in FIG. 13 are omitted or changed, or other components are added. For example, the first to N-th sensors 200-1 to 200-N and the analog front ends 210-1 to 210-N may not be components of the signal processing device 100.

Configurations and functions of the first to N-th sensors 200-1 to 200-N, the analog front ends 210-1 to 210-N, the storage circuit 120, the operation unit 130, the display unit 140, the sound output unit 150, and the communication unit 160 are the same as those in the first embodiment, and thus description thereof will be omitted.

The processing circuit 110 functions as the time waveform acquisition circuit 111, the frequency spectrum generation circuit 112, the first state index calculation circuit 113, and a second state index calculation circuit 114 by executing the signal processing program 121 stored in the storage circuit 120. That is, the signal processing device 100 includes the time waveform acquisition circuit 111, the frequency spectrum generation circuit 112, the first state index calculation circuit 113, and the second state index calculation circuit 114.

Functions of the time waveform acquisition circuit 111, the frequency spectrum generation circuit 112, and the first state index calculation circuit 113 are the same as those in the first embodiment, and thus description thereof will be omitted.

The second state index calculation circuit 114 calculates a difference between a phase of the third signal component corresponding to a third peak included in the first frequency spectrum generated by the frequency spectrum generation circuit 112 and a phase of a fourth signal component that corresponds to a fourth peak included in a j-th frequency spectrum and has the same frequency as a frequency of the third signal component for each integer j of 2 or more and N or less as an index indicating a state of the object. That is, the second state index calculation circuit 114 executes the second state index calculation step S40 shown in FIG. 10. The index calculated by the second state index calculation circuit 114 is stored in the storage circuit 120.

As described above, the signal processing program 121 is a program that causes the processing circuit 110 which is a computer to execute the time waveform acquisition step S10, the frequency spectrum generation step S20, the first state index calculation step S30, and the second state index calculation step S40.

At least some of the time waveform acquisition circuit 111, the frequency spectrum generation circuit 112, the first state index calculation circuit 113, and the second state index calculation circuit 114 may be implemented by dedicated hardware.

According to the signal processing method of the second embodiment described above, the same effects as those of the signal processing method according to the first embodiment can be obtained. Further, according to the signal processing method of the second embodiment, the signal processing device 100 can calculate a difference between the phase of the third signal component included in the first time waveform and the phase of the fourth signal component included in the second to N-th time waveforms as an index indicating a state of the object.

### 3. Third Embodiment

Hereinafter, in the third embodiment, the same components as those of the first embodiment or the second embodiment are denoted by the same reference numerals, description overlapping with the first embodiment or the second embodiment is omitted or simplified, and contents different from the first embodiment or the second embodiment will be mainly described.

FIG. 14 is a flowchart showing a procedure of a signal processing method according to the third embodiment. As shown in FIG. 14, the signal processing method according to the third embodiment includes the time waveform acquisition step S10, the frequency spectrum generation step S20, the first state index calculation step S30, the second state index calculation step S40, a third state index calculation step S70, and a Lissajous figure generation step S80. Further, the signal processing method according to the third embodiment may include at least one of an integration step S50 and a differentiation step S60. In the signal processing method according to the third embodiment, some of these steps may be omitted or changed, or other steps may be added. The signal processing method according to the third embodiment is executed by, for example, the signal processing device 100. A configuration example of the signal processing device 100 that executes the signal processing method according to the third embodiment will be described later.

As shown in FIG. 14, first, the signal processing device 100 executes the time waveform acquisition step S10 in a similar manner to that in FIG. 2 or FIG. 10 to acquire the first to N-th time waveforms. In the third embodiment, the integer N is 2 or more.

Next, the signal processing device 100 executes the frequency spectrum generation step S20 in a similar manner to that in FIG. 2 or FIG. 10. Next, the signal processing device 100 executes the first state index calculation step S30 in a similar manner to that in FIG. 2 or FIG. 10. Next, the signal processing device 100 executes the second state index calculation step S40 in a similar manner to that in FIG. 10.

Next, in the integration step S50, the signal processing device 100 executes integration processing on the i-th time waveform acquired in the time waveform acquisition step S10 for each integer i of 1 or more and N or less. For example, assuming that the integer N is 3, the signal processing device 100 integrates the time waveform of the x-axis velocity Vx, the time waveform of the y-axis velocity Vy, and the time waveform of the z-axis velocity Vz shown in FIG. 4 acquired as the first to third time waveforms, and generates a time waveform of an x-axis displacement Dx, a time waveform of a y-axis displacement Dy, and a time waveform of a z-axis displacement Dz.

Next, in the differentiation step S60, the signal processing device 100 executes differentiation processing on the i-th time waveform acquired in the time waveform acquisition step S10 for each integer i of 1 or more and N or less. For example, assuming that the integer N is 3, the signal processing device 100 differentiates the time waveform of the x-axis velocity Vx, the time waveform of the y-axis velocity Vy, and the time waveform of the z-axis velocity Vz shown in FIG. 4 acquired as the first to third time waveforms, and generates a time waveform of an x-axis acceleration Ax, a time waveform of a y-axis acceleration Ay, and a time waveform of a z-axis acceleration Az.

Next, in the third state index calculation step S70, the signal processing device 100 calculates a vector serving as an index indicating a state of the object based on the first to N-th time waveforms acquired in the time waveform acquisition step S10. The signal processing device 100 may calculate, as the vector serving as an index indicating a state of the object, an N-dimensional vector having time values of the first to N-th time waveforms as elements. The signal processing device 100 may calculate an N-dimensional vector having, as elements, time values of N time waveforms obtained by integrating the first to N-th time waveforms in the integration step S50, or may calculate an N-dimensional vector having, as elements, time values of N time waveforms obtained by differentiating the first to N-th time waveforms in the differentiation step S60. The signal processing device 100 may calculate an N-dimensional tangent vector by differentiating any one of the N-dimensional vectors, or may calculate an N-dimensional principal normal vector by further differentiating the N-dimensional tangent vector. For example, when an N-dimensional vector is a displacement vector, the tangent vector is a velocity vector, and the principal normal vector is an acceleration vector. The signal processing device 100 may calculate a sub normal vector that is an outer product of a tangent vector and a principal normal vector as the vector serving as an index indicating a state of the object, or may calculate a vibration surface normal vector obtained by further converting the sub normal vector into a unit vector.

Next, in the Lissajous figure generation step S80, the signal processing device 100 generates a Lissajous figure based on the vector calculated in the third state index calculation step S70. The signal processing device 100 may generate a Lissajous figure indicating a trajectory of the N-dimensional vector, the tangent vector, the principal normal vector, the sub normal vector, or the vibration surface normal vector.

The signal processing device 100 repeatedly executes steps S10 to S80 until the signal processing ends (N in step S100). The signal processing device 100 may execute the differentiation step S60 before the integration step S50, or may not execute at least one of the integration step S50 and the differentiation step S60.

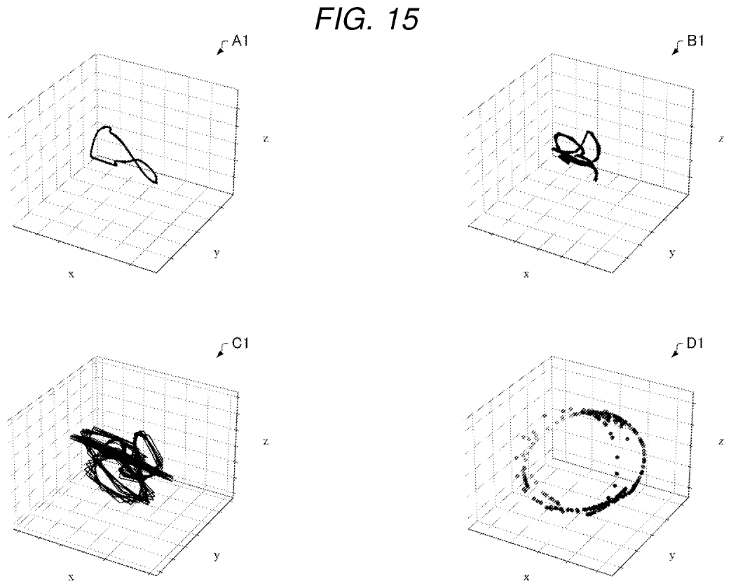

FIG. 15 shows an example of the Lissajous figures generated in the Lissajous figure generation step S80. In FIG. 15, A1 is a Lissajous figure indicating a trajectory of a three-dimensional displacement vector calculated based on the time waveform of the x-axis displacement Dx, the time waveform of the y-axis displacement Dy, and the time waveform of the z-axis displacement Dz generated by integrating the time waveform of the x-axis velocity Vx, the time waveform of the y-axis velocity Vy, and the time waveform of the z-axis velocity Vz shown in FIG. 4 in the integration step S50. B1 is a Lissajous figure indicating a trajectory of a three-dimensional velocity vector serving as a tangent vector obtained by differentiating the displacement vector of A1. C1 is a Lissajous figure indicating a trajectory of a three-dimensional acceleration vector serving as a principal normal vector obtained by further differentiating the velocity vector of B1. D1 is a Lissajous figure indicating a trajectory of a vibration surface normal vector obtained by converting a sub normal vector which is an outer product of the velocity vector of B1 and the acceleration vector of C1 into a unit vector. It is understood that any one of the Lissajous figures shown in FIG. 15 indicates a trajectory having a certain degree of regularity.

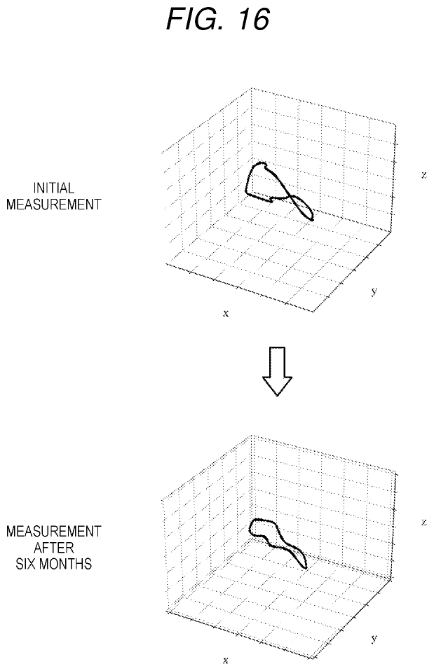

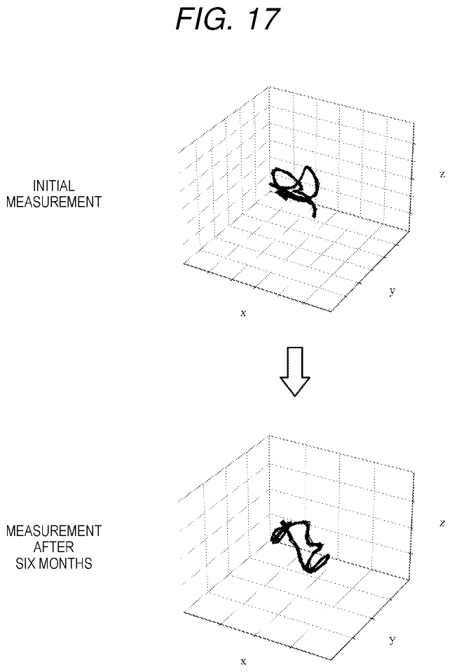

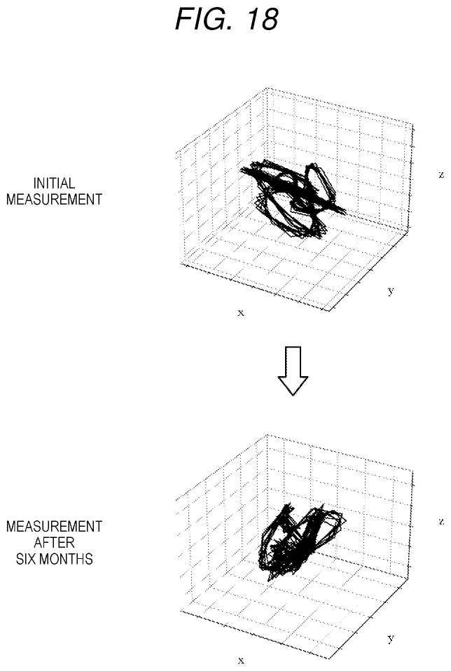

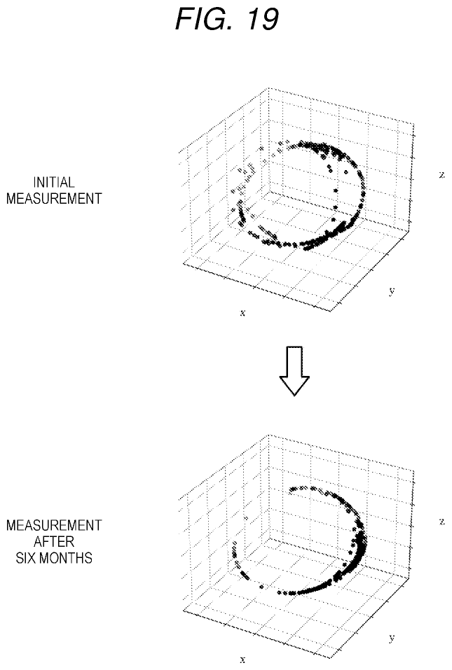

A user can monitor the Lissajous figures generated in the Lissajous figure generation step S80, and can estimate that a state of the object changes when there is a temporal change in regularity of a trajectory of a vector. FIG. 16 shows an example of a temporal change in trajectories of the displacement vector in A1 shown in FIG. 15. FIG. 17 shows an example of a temporal change in trajectories of the velocity vector in B1 shown in FIG. 15. FIG. 18 shows an example of a temporal change in trajectories of the acceleration vector in C1 shown in FIG. 15. FIG. 19 shows an example of a temporal change in trajectories of the vibration surface normal vector in D1 shown in FIG. 15. In any one of trajectories shown in FIGS. 16 to 19, regularity changes after six months, and it is estimated that a state of the object changes during the six months.

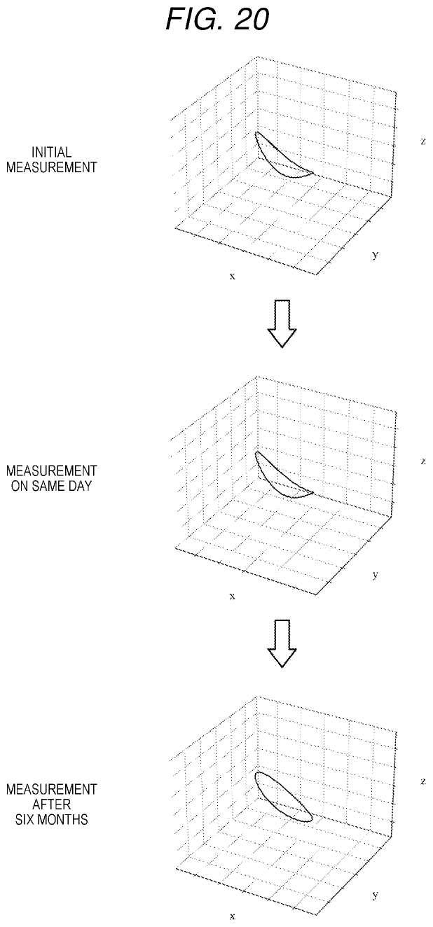

In the third state index calculation step S70, the signal processing device 100 may extract a signal component having a specific frequency included in the first to N-th time waveforms and calculate a vector serving as an index indicating a state of the object. For example, the signal processing device 100 may generate a time waveform of the x-axis velocity, a time waveform of the y-axis velocity, and a time waveform of the z-axis velocity obtained by extracting a fundamental wave component of about 84 Hz, a second harmonic wave component, a third harmonic wave component, and a fourth harmonic wave component from the time waveform of the x-axis velocity Vx, the time waveform of the y-axis velocity Vy, and the time waveform of the z-axis velocity Vz shown in FIG. 4, and calculate a three-dimensional velocity vector serving as an index indicating a state of the object based on the generated three time waveforms. FIG. 20 shows an example of a temporal change of Lissajous figures indicating trajectories of the three-dimensional velocity vector. In the trajectories shown in FIG. 20, regularity also changes after six months, and it is estimated that a state of the object changes during the six months.

The signal processing device 100 may further calculate a geometric feature of a Lissajous figure, for example, a long axis or a short axis of an ellipse, a normal vector of an ellipsoid, or the like, as an index indicating a state of the object.

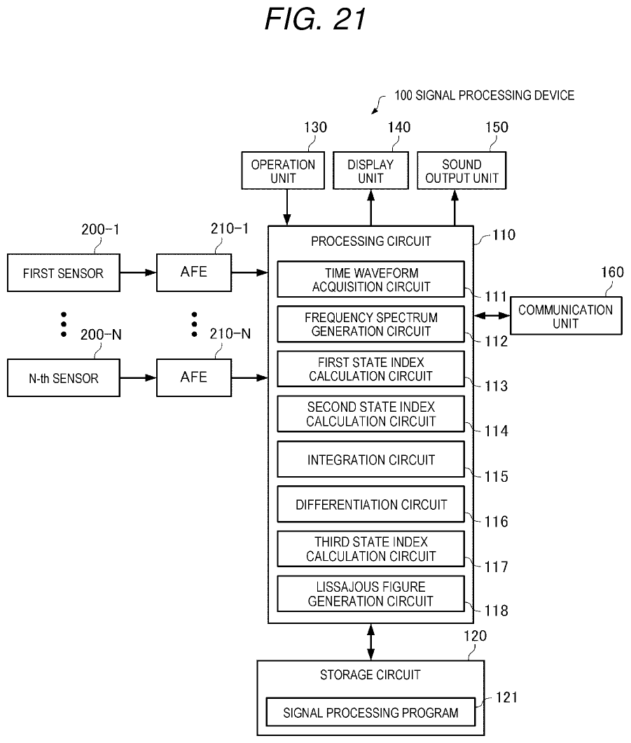

FIG. 21 shows a configuration example of the signal processing device 100 that executes the signal processing method according to the third embodiment. As shown in FIG. 21, the signal processing device 100 includes the first to N-th sensors 200-1 to 200-N, the N analog front ends 210-1 to 210-N, the processing circuit 110, the storage circuit 120, the operation unit 130, the display unit 140, the sound output unit 150, and the communication unit 160. The signal processing device 100 may have a configuration in which some of the components shown in FIG. 21 are omitted or changed, or other components are added. For example, the first to N-th sensors 200-1 to 200-N and the analog front ends 210-1 to 210-N may not be components of the signal processing device 100.

Configurations and functions of the first to N-th sensors 200-1 to 200-N, the analog front ends 210-1 to 210-N, the storage circuit 120, the operation unit 130, the display unit 140, the sound output unit 150, and the communication unit 160 are the same as those in the first embodiment or the second embodiment, and thus description thereof will be omitted.

The processing circuit 110 functions as the time waveform acquisition circuit 111, the frequency spectrum generation circuit 112, the first state index calculation circuit 113, the second state index calculation circuit 114, an integration circuit 115, a differentiation circuit 116, a third state index calculation circuit 117, and a Lissajous figure generation circuit 118 by executing the signal processing program 121 stored in the storage circuit 120. That is, the signal processing device 100 includes the time waveform acquisition circuit 111, the frequency spectrum generation circuit 112, the first state index calculation circuit 113, the second state index calculation circuit 114, the integration circuit 115, the differentiation circuit 116, the third state index calculation circuit 117, and the Lissajous figure generation circuit 118.

Functions of the time waveform acquisition circuit 111, the frequency spectrum generation circuit 112, the first state index calculation circuit 113, and the second state index calculation circuit 114 are the same as those in the first embodiment or the second embodiment, and thus description thereof will be omitted.

The integration circuit 115 executes integration processing on the i-th time waveform acquired by the time waveform acquisition circuit 111 for each integer i of 1 or more and N or less. That is, the integration circuit 115 executes the integration step S50 shown in FIG. 14. N time waveforms obtained by the integration processing of the integration circuit 115 are stored in the storage circuit 120.

The differentiation circuit 116 executes differentiation processing on the i-th time waveform acquired by the time waveform acquisition circuit 111 for each integer i of 1 or more and N or less. That is, the differentiation circuit 116 executes the differentiation step S60 shown in FIG. 14. N time waveforms obtained by the differentiation processing of the differentiation circuit 116 are stored in the storage circuit 120.

The third state index calculation circuit 117 calculates a vector serving as an index indicating a state of the object based on the first to N-th time waveforms acquired by the time waveform acquisition circuit 111. That is, the third state index calculation circuit 117 executes the third state index calculation step S70 shown in FIG. 14. The vector calculated by the third state index calculation circuit 117 is stored in the storage circuit 120.

The Lissajous figure generation circuit 118 generates a Lissajous figure based on the vector calculated by the third state index calculation circuit 117. That is, the Lissajous figure generation circuit 118 executes the Lissajous figure generation step S80 shown in FIG. 14. The Lissajous figure generated by the Lissajous figure generation circuit 118 is displayed by the display unit 140.

As described above, the signal processing program 121 is a program that causes the processing circuit 110 which is a computer to execute the time waveform acquisition step S10, the frequency spectrum generation step S20, the first state index calculation step S30, the second state index calculation step S40, the integration step S50, the differentiation step S60, the third state index calculation step S70, and the Lissajous figure generation step S80.

At least some of the time waveform acquisition circuit 111, the frequency spectrum generation circuit 112, the first state index calculation circuit 113, the second state index calculation circuit 114, the integration circuit 115, the differentiation circuit 116, the third state index calculation circuit 117, and the Lissajous figure generation circuit 118 may be implemented by dedicated hardware.

According to the third embodiment described above, the same effects as those of the signal processing method according to the first embodiment or the second embodiment can be obtained. Furthermore, according to the signal processing method of the third embodiment, since the signal processing device 100 calculates a vector serving as an index indicating a state of the object, information reflecting the state of the object can be obtained with a relatively small data amount. According to the signal processing method of the third embodiment, a user can visually understand a state of an object using a Lissajous figure.

The above-described embodiments and modifications are examples, and the present disclosure is not limited thereto. For example, the embodiments and the modifications may be combined as appropriate.

The present disclosure includes substantially the same configuration (for example, a configuration having the same function, method, and result, or a configuration having the same object and effect) as the configuration described in the embodiments. The present disclosure includes a configuration in which a non-essential portion of the configuration described in the embodiments is replaced. The present disclosure includes a configuration capable of achieving the same function and effect or a configuration capable of achieving the same object as the configuration described in the embodiments. The present disclosure includes a configuration obtained by adding a known technique to the configuration described in the embodiments.

The following contents are derived from the above-described embodiments and modifications.

One aspect of a signal processing method includes: a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more; a frequency spectrum generation step of generating an i-th frequency spectrum for each integer i based on the i-th time waveform; and a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

According to the signal processing method, since the difference between the phase of the first signal component and the phase of the second signal component is calculated based on the first to N-th time waveforms, a rotation pulse signal is not required, and it is not required to use a PLL, a tracking filter, a low-pass filter, and the like in combination. Further, since phases of various signal components included in the first to N-th time waveforms include information corresponding to a state of the object, the difference between the phase of the first signal component included in the first time waveform and the phase of the second signal component included in the first to N-th time waveforms can be calculated as an index indicating the state of the object. As described above, according to the signal processing method, the index indicating the state of the object can be calculated without requiring a rotation pulse signal.

In the aspect of the signal processing method, the frequency of the second signal component may be a natural number multiple of the frequency of the first signal component.

According to the signal processing method, since the second signal component is a harmonic wave component having the first signal component as a fundamental wave component, a difference between a phase of the fundamental wave component and a phase of the harmonic wave component can be calculated as an index indicating a state of the object.

In the aspect of the signal processing method, the integer N may be 2 or more.

According to the signal processing method, an index based on a plurality of time waveforms is obtained as an index indicating a state of the object.

The aspect of the signal processing method may further include: a second state index calculation step of calculating, for each integer j of 2 or more and N or less, a difference between a phase of a third signal component corresponding to a third peak included in the first frequency spectrum and a phase of a fourth signal component that corresponds to a fourth peak included in a j-th frequency spectrum and has the same frequency as a frequency of the third signal component as an index indicating a state of the object.

According to the signal processing method, the difference between the phase of the third signal component included in the first time waveform and the phase of the fourth signal component included in the second to N-th time waveforms can be calculated as the index indicating the state of the object.

The aspect of the signal processing method may further include: a third state index calculation step of calculating a vector serving as the index indicating the state of the object based on the first to N-th time waveforms.

According to the signal processing method, information reflecting a state of the object can be obtained with a relatively small data amount.

The aspect of the signal processing method may further include: a Lissajous figure generation step of generating a Lissajous figure indicating a trajectory of the vector.

According to the signal processing method, a user can visually understand a state of the object using the Lissajous figure.

One aspect of a signal processing device includes: a time waveform acquisition circuit configured to acquire, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more; a frequency spectrum generation circuit configured to generate an i-th frequency spectrum for each integer i based on the i-th time waveform; and a first state index calculation circuit configured to calculate, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

According to the signal processing device, the index indicating the state of the object can be calculated without requiring a rotation pulse signal.

An aspect of a signal processing program is a program for causing a computer to execute: a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more; a frequency spectrum generation step of generating an i-th frequency spectrum for each integer i based on the i-th time waveform; and a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

According to the signal processing program, the index indicating the state of the object can be calculated without requiring a rotation pulse signal.

What is claimed is:

1. A signal processing method comprising:
a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more;
a frequency spectrum generation step of generating an i-th frequency spectrum for each integer i based on the i-th time waveform; and
a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

2. The signal processing method according to claim 1, wherein
the frequency of the second signal component is a natural number multiple of the frequency of the first signal component.

3. The signal processing method according to claim 1, wherein
the integer N is 2 or more.

4. The signal processing method according to claim 3, further comprising:
a second state index calculation step of calculating, for each integer j of 2 or more and N or less, a difference between a phase of a third signal component corresponding to a third peak included in the first frequency spectrum and a phase of a fourth signal component that corresponds to a fourth peak included in a j-th frequency spectrum and has the same frequency as a frequency of the third signal component as an index indicating a state of the object.

5. The signal processing method according to claim 3, further comprising:
a third state index calculation step of calculating a vector serving as an index indicating a state of the object based on the first to N-th time waveforms.

6. The signal processing method according to claim 5, further comprising:
a Lissajous figure generation step of generating a Lissajous figure indicating a trajectory of the vector.

7. A signal processing device comprising:
a time waveform acquisition circuit configured to acquire, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more;
a frequency spectrum generation circuit configured to generate an i-th frequency spectrum for each integer i based on the i-th time waveform; and
a first state index calculation circuit configured to calculate, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.

8. A signal processing program for causing a computer to execute:
a time waveform acquisition step of acquiring, from an i-th sensor, an i-th time waveform related to an i-th physical quantity generated by an external force, a velocity, or a displacement having at least a periodic variation acting on an object for each integer i of 1 or more and N or less with N being a predetermined integer of 1 or more;
a frequency spectrum generation step of generating an i-th frequency spectrum for each integer i based on the i-th time waveform; and
a first state index calculation step of calculating, for each integer i, a difference between a phase of a first signal component corresponding to a first peak included in a first frequency spectrum and a phase of a second signal component that corresponds to a second peak included in the i-th frequency spectrum and has a frequency that is a rational multiple of a frequency of the first signal component as an index indicating a state of the object.
